(19) United States
(12) Patent Application Publication
(10) Pub. No.: US 2026/0162054 A1
(43) Pub. Date: Jun. 11, 2026

(54) SYSTEMS AND METHODS FOR BIDIRECTIONAL PROVISIONING OF SECURE, EFFICIENT NAVIGATION, PHYSICAL RETURN, AND SCHEDULING

(71) Applicant: Vanessa E. Simms, Odenton, MD (US)

(72) Inventor: Vanessa E. Simms, Odenton, MD (US)

(21) Appl. No.: 19/456,708

(22) Filed: Jan. 22, 2026

Related U.S. Application Data
(63) Continuation of application No. 18/512,982, filed on Nov. 17, 2023, now abandoned.

(51) Int. Cl. G06Q 10/0837

(52) U.S. Cl. CPC G06Q 10/0837

(57) ABSTRACT

A computer-implemented system for facilitating package returns. In some implementations, the device may provision an application platform accessible by a first user; host the application platform for the first user to navigate, register on, and use, the application platform; enable the first user to arrange return services; require the first user to provide necessary information; enable the first user to request items available at a desired return location. The system may include a user interface, a communication module, and a notification module. This technology is configured to facilitate a user-friendly and efficient process for accessing and utilizing an application platform, arranging return services, and requesting items at a desired return location.

### REFERENCE TO RELATED APPLICATIONS

This application is a continuation of U.S. application Ser. No. 18/512,982, which is incorporated herein by reference.

### TECHNICAL FIELD

The invention pertains to a software application and system that facilitates provisioning secure transportation of return packages through scheduling (coordinating) a networked return vehicle, with additional features for in-app item pickups at the selected return location.

### BACKGROUND

In the modern era, the rise of e-commerce has led to an increase in the number of packages being delivered and returned on a daily basis. This has created a need for efficient and reliable return services. However, managing these returns can be a complex task, involving various factors such as scheduling, coordinating, routing, pricing, resource allocation, and security. Moreover, the process of returning a package can be inconvenient for customers, who often have to go through the hassle of packaging the item, finding a suitable return location, and arranging for the return. This can be particularly challenging for customers with multiple packages or large, bulky items.

Additionally, the process of managing returns can be challenging for service providers as well. They need to optimize their routes to minimize travel time and costs, match workers to jobs (tasks) based on their skills, capability, and availability, allocate resources efficiently, and ensure the security of transactions (exchanges). Furthermore, the quality of the package being returned is another important consideration. Packages can vary greatly in terms of weight, size, type, and other factors, and these variations can impact the return process.

This application relates to solving this need with a more fuel efficient and convenient way to provision package return transportation using secure software applications and data processing, vehicles, navigation, and communication networks.

### SUMMARY

In some aspects, the techniques described herein relate to a non-transitory computer-readable medium storing instructions that, when executed by a processor, cause the processor to: provision an application platform accessible by a first user; host the application platform for the first user to navigate, register on, and use, the application platform; enable the first user to arrange return services; require the first user to provide necessary information; enable the first user to request items available at a desired return location.

In some aspects, the techniques described herein relate to a system for facilitating return scheduling (coordinating) through a digital platform, the system including: a user interface for receiving return package transportation scheduling (coordination) requests (interrogations) from one or more first users; a communication module for transmitting the return package transportation scheduling (coordinating) requests (interrogations) to one or more second users and receiving confirmation of the return scheduling (coordinating) from the one or more second users; and a notification module for notifying the one or more first users of the confirmed return scheduling (coordinating).

### BRIEF DESCRIPTION OF THE FIGURES

FIG. 1 is a diagram of an example environment in which systems and/or methods described herein may be implemented.

FIG. 2 is a diagram of components of a test device, according to an example of the present disclosure.

FIG. 3 depicts a sample technological environment in accordance with certain embodiments.

FIG. 4 depicts a block diagram of a data processing in an example software application provisioning secure return package transportation in accordance with certain embodiments.

FIG. 5 illustrates a computer interface which may be used to process data for vehicle navigation, transportation, and scheduling in accordance with certain embodiments.

FIG. 6 illustrates a sample embodiment of a user device which may be used to process data for vehicle navigation, transportation, and scheduling in accordance with certain embodiments.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high level, without detail, to avoid unnecessarily obscuring aspects of the present teachings.

To address the challenges mentioned in the background section, this patent discloses a computerized method and system enabling return scheduling (coordinating) through a digital platform which is configured to process data for vehicle navigation, transportation, and scheduling. This is done securely and, in some aspects, to optimize for fuel economy.

The system utilizes a software application configured to perform a series of steps, including receiving and transmitting return scheduling (coordinating) requests (interrogations) from first users to second users, also known as drivers, receiving confirmation from drivers, and notifying first users. It also includes determining optimized routing for fuel efficiency, dynamically matching second users/drivers, allocating resources, and verifying identities of first users and second users, all based on algorithms considering various relevant factors. The system may be similarly equipped for these functions with a cloud or hybrid cloud network architecture. In-app bidirectional secure package transportation requests may also be facilitated. Transaction (exchange) security may be ensured with blockchain (hash-linked chain) technology and hardware authentication. Moreover, the software application utilizes return item characteristics such as weight, size, and type.

Various processes described herein may be implemented by appropriately programmed general purpose computers, special purpose computers, and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hard-wired circuitry or custom hardware may be used in place of, or in combination with, some or all of the software instructions that can implement the processes. Algorithms other than those described may be used.

Programs and data may be stored in various media appropriate to the purpose, or a combination of heterogeneous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on an Intel® or AMD® processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices.

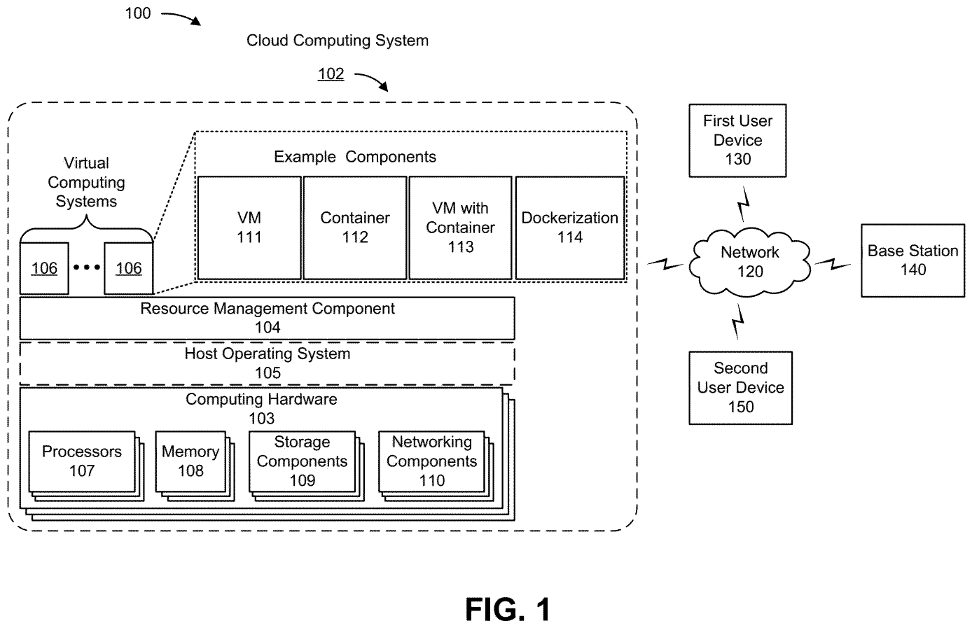

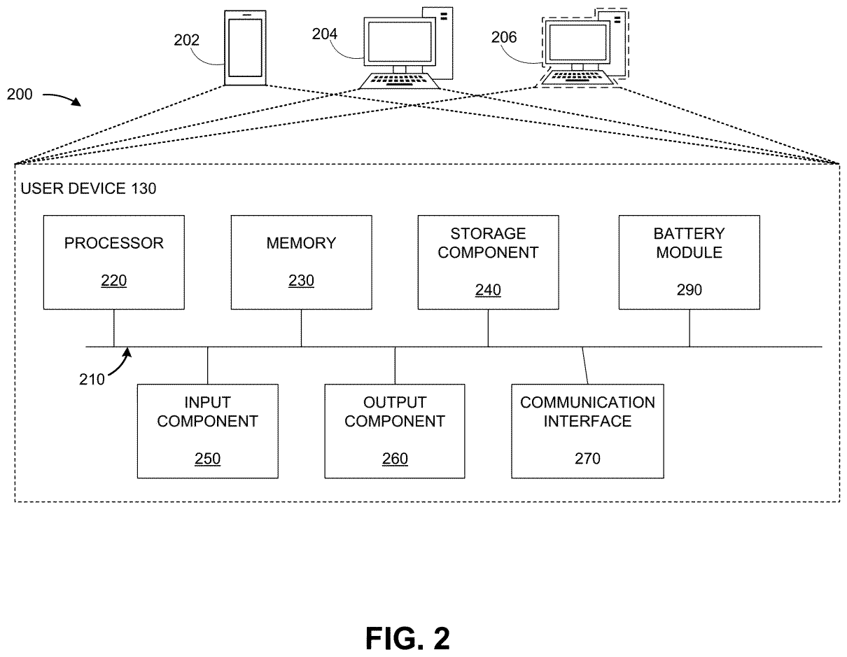

With reference to the figures and in particular, with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 is a diagram of an example environment 100 in which systems and/or methods described herein may be implemented. As shown in FIG. 1, the environment 100 may execute within a cloud computing system 102. The cloud computing system 102 may include one or more elements 103-113, as described in more detail below. As further shown in FIG. 1, the environment 100 may include a network 120, a first user device 130, and/or a base station 140. Devices and/or elements of the environment 100 may interconnect via wired connections and/or wireless connections. It is important to note that first user device 130, as described herein, is a user device which may be used by the first user and/or the second user. In the later case, when it is used by the second user, user device 130 may also be called a second user device 130. For purposes of convenience in reading this description, the embodiment of the user device 130 as a first user device will be described, but it should be understood as interchangeably termed “second user device” at least for the purposes of the disclosures of FIG. 1 and FIG. 2.

The cloud computing system 102 includes computing hardware 103, a resource management component 104, a host operating system (OS) 105, and/or one or more virtual computing systems 106. The resource management component 104 may perform virtualization (e.g., abstraction) of the computing hardware 103 to create the one or more virtual computing systems 106. Using virtualization, the resource management component 104 enables a single computing device (e.g., a computer, a server, and/or the like) to operate like multiple computing devices, such as by creating multiple isolated virtual computing systems 106 from the computing hardware 103 of the single computing device. In this way, the computing hardware 103 can operate more efficiently, with lower power consumption, higher reliability, higher availability, higher utilization, greater flexibility, and lower cost than using separate computing devices.

The computing hardware 103 includes hardware and corresponding resources from one or more computing devices. For example, the computing hardware 103 may include hardware from a single computing device (e.g., a single server) or from multiple computing devices (e.g., multiple servers), such as multiple computing devices in one or more data centers. As shown, the computing hardware 103 may include one or more processors 107, one or more memories 108, one or more storage components 109, and/or one or more networking components 110. Examples of a processor, a memory, a storage component, and a networking component (e.g., a communication component) are described elsewhere herein.

The resource management component 104 includes a virtualization application (e.g., executing on hardware, such as the computing hardware 103) capable of virtualizing the computing hardware 103 to start, stop, and/or manage the one or more virtual computing systems 106. For example, the resource management component 104 may include a hypervisor (e.g., a bare-metal or Type 1 hypervisor, a hosted or Type 2 hypervisor, and/or the like) or a virtual machine monitor, such as when the virtual computing systems 106 are virtual machines 111. Additionally, or alternatively, the resource management component 104 may include a container manager, such as when the virtual computing systems 106 are containers 112. In some implementations, the resource management component 104 executes within and/or in coordination with a host operating system 105.

A virtual computing system 106 includes a virtual environment that enables cloud-based execution of operations and/or processes described herein using computing hardware 103. As shown, the virtual computing system 106 may include a virtual machine 111, a container 112, a hybrid environment 113 that includes a virtual machine and a container, an environment which includes Docker-like filesystems or other possible Dockerization 114 with a VM or other computing hardware allocation, and/or the like. A virtual computing system 106 may execute one or more applications using a file system that includes binary files, software libraries, and/or other resources required to execute applications on a guest operating system (e.g., within the virtual computing system 106) or the host operating system 105.

The network 120 includes one or more wired and/or wireless networks. For example, the network 120 may include a cellular network, a public land mobile network (PLMN), a local area network (LAN), a wide area network (WAN), a satellite network, a private network, the Internet, and/or the like, and/or a combination of these or other types of networks. The network 120 enables communication among the devices of the environment 100.

First user device 130 may be possessed by a first user and includes one or more devices capable of receiving, generating, storing, processing, and/or providing information, as described elsewhere herein. First user device 130 may include a communication device and/or a computing device. For example, first user device 130 may include a wireless communication device, a mobile phone, a user equipment (UE), a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The base station 140 may support, for example, a cellular radio access technology (RAT). The base station may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the base station 140. The first user device 130 may transfer traffic (network load) between the base station 140 (e.g., using a cellular RAT), one or more base stations (e.g., using a wireless interface or a backhaul interface, such as a wired backhaul interface), and/or a core network. The first user device 130 may provide one or more cells that cover geographic areas.

The second user device 150 may be possessed by a second user and includes one or more devices capable of receiving, generating, storing, processing, and/or providing information, as described elsewhere herein. Second user device 150 may include a communication device and/or a computing device, and may be connected to, or embedded anywhere within, a vehicle or other equipment known to be utilized in the transportation industry. For example, second user device 150 may include a wireless communication device, a mobile phone, a vehicle computer system, a mobile printer, a calculator, a user equipment, a laptop computer, a tablet computer, a desktop computer, a set-top box, a wearable communication device (e.g., a smart wristwatch, a pair of smart eyeglasses, a head mounted display, or a virtual reality headset), or a similar type of device.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

FIG. 2 is a diagram of components of first user device 130, according to an example of the present disclosure. First user device 130 may include a bus 210, a processor 220, a memory 230, a storage component 240, an input component 250, an output component 260, a communication interface 270, and battery module 290.

Bus 210 includes a component that permits communication among the components of First user device 130. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 220 includes one or more processors capable of being programmed to perform a function. Memory 230 may include one or more memories such as a random access memory (RAM), a read only memory (ROM), and/or another type of dynamic or static storage device (e.g., a flash memory, a magnetic memory, and/or an optical memory) that stores information and/or instructions for use by processor 220. In some embodiments, a non-transitory computer-readable medium stores instructions that, when executed by a processor, cause the processor to perform various functions.

Storage component 240 stores information and/or software related to the operation and use of First user device 130. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits first user device 130 to receive information, such as via user input (e.g., a touch screen display, a keyboard, a keypad, a mouse, a button, a switch, and/or a microphone). Additionally, or alternatively, input component 250 may include a sensor for sensing information (e.g., a GPS component, an accelerometer, a gyroscope, and/or an actuator). Output component 260 includes a component that provides output information from first user device 130 (e.g., a display, a speaker, a user interface, and/or one or more light-emitting diodes (LEDs)). Output component 260 may include a display providing a GUI, such as interface 500. Input component 250 and output component 260 may be combined into a single component, such as a touch responsive display, also known as a touchscreen.

Communication interface 270 includes a transceiver-like component (e.g., a transceiver and/or a separate receiver and transmitter) that enables first user device 130 to communicate with other devices, such as via a wired connection, a wireless connection, or a combination of wired and wireless connections. Communication interface 270 may permit first user device 130 to receive information from another device and/or provide information to another device. Communication interface 270 may include one or more RFFEs (radio frequency front ends) with antennae circuitry and RF (radio frequency) filters which may be variable power and/or purpose adapted for various communication frequencies, standards, links, and distances. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 210 to supply power to processor 220, memory 230, and internal components of first user device 130. Battery module 290 may supply power during field measurements by first user device 130. Battery module 290 permits First user device 130 to be a portable integrated device for conducting field measurements of propagation delay in a RAN.

First user device 130 may perform one or more processes described herein. First user device 130 may perform these processes by processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, first user device 130 may include additional components, fewer components, different components, or differently arranged components than those shown in FIG. 2, 200. Additionally, or alternatively, a set of components (e.g., one or more components) of first user device 130 may perform one or more functions described as being performed by another set of components of first user device 130.

FIG. 2 is a diagram of components of first user device 130, according to an example of the present disclosure. First user device 130 may include a bus 210, a processor 220, a memory 230, a storage component 240, an input component 250, an output component 260, a communication interface 270, and battery module 290.

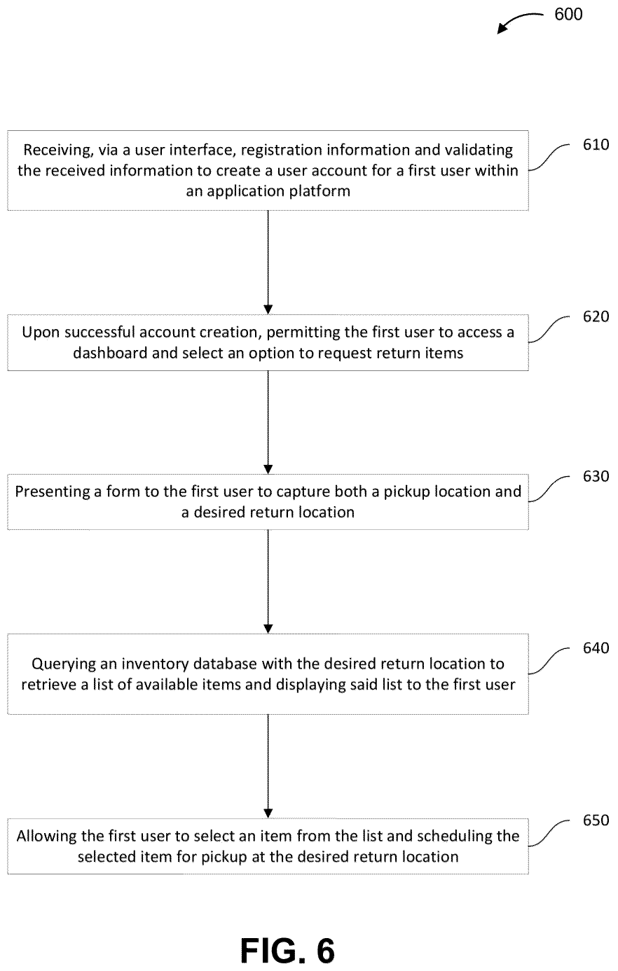

Bus 210 includes a component that permits communication among the components of First user device 130. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 220 includes one or more processors capable of being programmed to perform a function. According to an example, processor 220 is processor 220 of FIG. 6. Memory 230 may include one or more memories such as a random-access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of First user device 130. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits first user device 130 to receive information, such as via user input (e.g., a touch screen display, a keyboard, a keypad, a mouse, a button, a switch, and/or a microphone). Additionally, or alternatively, input component 250 may include a sensor for sensing information (e.g., a GPS component, an accelerometer, a gyroscope, and/or an actuator). Output component 260 includes a component that provides output information from first user device 130 (e.g., a display, a speaker, a user interface, and/or one or more light-emitting diodes (LEDs)). Output component 260 may include a display providing a GUI, such as interface 500. Input component 250 and output component 260 may be combined into a single component, such as a touch responsive display, also known as a touchscreen.

Communication interface 270 includes a transceiver-like component (e.g., a transceiver and/or a separate receiver and transmitter) that enables first user device 130 to communicate with other devices, such as via a wired connection, a wireless connection, or a combination of wired and wireless connections. Communication interface 270 may include one or more short range communication interface modules and medium/long range communication interface modules, and may permit first user device 130 to receive information from another device and/or provide information to another device. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 210 to supply power to processor 220, memory 230, and internal components of first user device 130. Battery module 290 permits First user device 130 to be a portable integrated device for conducting field measurements of propagation delay in a RAN.

First user device 130 may perform one or more processes described herein. First user device 130 may perform these processes by processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 220 to perform one or more processes described herein. Additionally, or alternatively, hardwired circuitry may be used in place of or in combination with software instructions to perform one or more processes described herein. Example embodiments second user device 150 may include a mobile device/user equipment (UE) 202, a personal computer 204, or a virtual computing system 206 which may include various implementations such as those of 106. Thus, implementations described herein are not limited to any specific combination of hardware circuitry and software.

The number and arrangement of components shown in FIG. 2 are provided as an example. In practice, first user device 130 may include additional components, fewer components, different components, or differently arranged components than those shown in FIG. 2. Additionally, or alternatively, a set of components (e.g., one or more components) of first user device 130 may perform one or more functions described as being performed by another set of components of first user device 130.

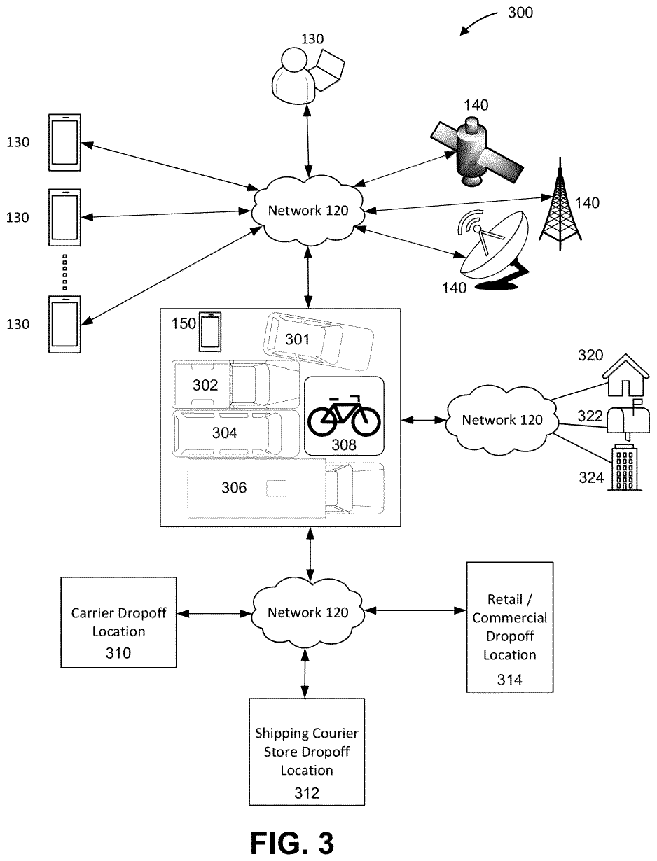

FIG. 3 illustrates an example embodiment of the technological environment in which the systems and software for provisioning secure and efficient vehicle navigation as applied to the technological environment shown for return package transportation and scheduling. The systems and software implements a method which includes receiving return package transportation scheduling (coordinating) requests (interrogations) from one or more first users' first user devices and transmitting these requests to one or more second users' second user devices to enable them to provide return package transportation services, and other transportation services. This may enable them to provide these services as drivers or riders of cars 301, trucks 302, vans 304, semi-trailor tractor trucks 306, and/or human powered vehicles 308 such as bicycles. These transportation vehicles may be second devices themselves with integrated wireless communications and electronic computer systems as discussed elsewhere and as known in the art, or they may be enabled by combination with a more purpose-specific user equipment such as a cell phone or other personal device which serves as navigation instrumentation and to enable other application platform interfacing.

In the same embodiment, the method also includes receiving confirmation of the return scheduling from the one or more second user devices and notifying the one or more first users of the confirmed return scheduling.

In another embodiment, the method further includes determining a route for the one or more second users to perform the return service using a route optimization mechanism. The determined route is then transmitted to the one or more second user devices.

In yet another embodiment, the route optimization mechanism considers factors such as traffic (network load), distance, time of day, and any specific tools required for each job (task). This may include tasks such as avoiding traffic, calculating estimated traffic at the time and place for the driver's driving habits and weather conditions, and/or suggesting stops along the way to gather needed tools and equipment for the package transportation provisioning. These stops may be at locations such as a residence 320, post box or postal location 322, or commercial location 324. These locations residence 320, location 322, and commercial location 324 may also be pickup locations specified by the first user when requesting transportation services for return packages through the application platform provided.

In many embodiments, dropoff locations 310-314 include various locations, coordinates, or addresses identified by the first user. As shown, these may include a carrier dropoff location 310 as designated by any shipping carrier, a shipping courier store dropoff location 312 such as a permanent UPS or FedEx location, or a retail/commercial dropoff location 314. One example of when a location may be a carrier dropoff location 310 but not a courier store dropoff location 312 is if USPS courier store dropoff addresses may be a designated location other than their store, such as a UPS address. There may be infinite examples of locations which may serve as carrier dropoff locations, since sometimes carriers may designate dropoff locations based on their customers' custom preferences for pickup locations. For example, a carrier may designate any of residence 320, postal location 322, or commercial location 324 as a carrier dropoff location 310; in this case the same address would most likely not serve as the pickup location but another of the same type of location may.

The application platform may exist anywhere the network 120 touches, and may be promulgated by base stations 140 for wireless access anywhere wireless networks or the internet is accessible. This technological environment 300 may generally be used to schedule return package transportation as disclosed by the embodiments herein.

In some embodiments, the request from a first user for return package transportation must include information regrading the quantity and approximate size of the return packages desired to be picked up and transported by a second user.

In a further embodiment, the method includes determining a price for the return service using a dynamic pricing mechanism. The determined price is then transmitted to the one or more users. In another embodiment, the dynamic pricing mechanism considers factors such as demand, distance, time of day, and any pickup complexities.

In a further embodiment, the method includes matching the one or more drivers/second users/service providers to the return service using a service provider matching mechanism. In yet another embodiment, the service provider matching mechanism considers factors such as skills, capability and tools prepossessed by the second user drivers, location, and availability of the second users/drivers.

In another embodiment, the method includes allocating resources for the return service using a resource allocation mechanism. In a further embodiment, the resource allocation mechanism considers factors such as demand, pickup location or desired return location/desired return location address, and/or other factors. This may estimate necessary transactions (exchanges) such as purchasing fuel along the way, transferring credits to the second user, providing access to stations with unlocked access to larger transportation vehicles, etc.

In yet another embodiment, the method includes verifying the identity of the one or more first users and the one or more second user drivers using a security and verification mechanism. The method also ensures the security of transactions using the security and verification mechanism.

In another embodiment, the security and verification mechanism uses blockchain (de-centralized database) technology or hardware authentications for secure, transparent transactions, and/or is designed for ensuring the security of transactions.

In another embodiment, the return package security verification module uses optical character recognition (OCR), symbol interpretation, and computer vision to analyze a return shipping receipt, such as to confirm proper handling by the second user and shipping courier company.

In yet another embodiment, the method comprises steps for verifying the identity of the one or more first users and the one or more second user drivers. This verification process is critical to maintaining the integrity and trust within the system. The method utilizes a robust security and verification mechanism that may include multi-factor authentication, biometric data verification, or real-time authorization checks to ensure that only authorized individuals can access and initiate transactions.

Furthermore, the method enhances the security of transactions using the same security and verification mechanism. It is designed to safeguard against unauthorized access, data breaches, and fraudulent activities. The system's architecture is such that it can detect and prevent security threats, ensuring that all transactions are conducted in a secure and protected environment.

In another embodiment, the security and verification mechanism leverages blockchain (hash-linked chain, de-centralized database) technology, which provides a de-centralized and immutable ledger for transaction recording. The blockchain's inherent characteristics such as transparency, traceability, and tamper-evident recording of transactions bolster the system's ability to prevent fraud. Every transaction is recorded as a block on the blockchain, linked to the preceding and subsequent blocks, thus creating a secure chain of transactions that is nearly impossible to alter retroactively.

Moreover, the security mechanism can incorporate hardware authentications, which may involve the use of physical devices such as security tokens, smart cards, or hardware security modules (HSMs). These devices provide an additional layer of security by requiring physical possession of the hardware to authenticate a transaction, thereby reducing the risk of remote hacking or identity theft.

Advanced encryption algorithms and AI-based security analysis tools set new systems apart from traditional solutions. For instance, quantum-resistant encryption methods are being developed to counter the potential future threat of quantum computing to current encryption standards. AI-driven security platforms can analyze vast amounts of data to detect subtle signs of security breaches that traditional systems might miss.

Each of these technologies contributes to a robust and comprehensive approach to security and verification in digital transactions, ensuring both reliability and user trust. This multi-faceted approach to security, encompassing both blockchain (hash-linked chain) technology and hardware authentications, ensures that the transactions are not only secure from tampering but also transparent and verifiable by all parties involved. Such a system is designed to instill confidence among users by demonstrating that the technology operates at the highest standards of security and reliability.

In a further embodiment, the method includes analysing characteristics of the items for return using a package analysis mechanism. In yet another embodiment, the package analysis mechanism is considering factors or considers factors such as information regarding approximate or exact weight, approximate or exact size, package/packaging type, risks of leaks or flammability, legality (compliance status) of substances, likelihood of tax requirements for customs handling (rates), and/or risks of packaging breaking. This information may be required to accompany the coordinate information submitted any time the first user submits a return package transportation scheduling request before provisioning any return package transportation scheduling within the application platform system.

In another embodiment, the method includes facilitating additional in-app item pick-ups or purchases from a return location by the one or more first users. These in app item pickup request transmissions are submitted through the first user's application interface to travel through the network to the second users' application interface, where they are able to be responded to in affirmation or refusal.

In a further embodiment, a system for facilitating return scheduling through a digital platform is disclosed. The system includes a user interface for receiving return scheduling (coordinating) requests (interrogations) from one or more first users, a communication module for transmitting return package transportation scheduling requests to one or more second users/drivers and receiving confirmation of the return scheduling from these one or more second users, and a notification module for notifying the one or more first users of the confirmed package return package transportation scheduling.

In many embodiments, the second users may interact through their account as a return operator role on the application platform.

In yet another embodiment, the system further includes a route optimization mechanism for determining a route for the one or more service providers to perform the return service. The communication module is further configured to transmit the determined route to the one or more second users.

In another embodiment, the system further includes a dynamic pricing mechanism for determining a price (value) for the return service. The communication module is further configured to transmit the determined price (value) to the one or more first users and/or second users.

In a further embodiment, the system includes a driver/second user matching mechanism for matching the one or more second users to the requested return package pickup/return service.

In yet another embodiment, the system includes a resource allocation mechanism for allocating resources for the return package transportation driver/second user.

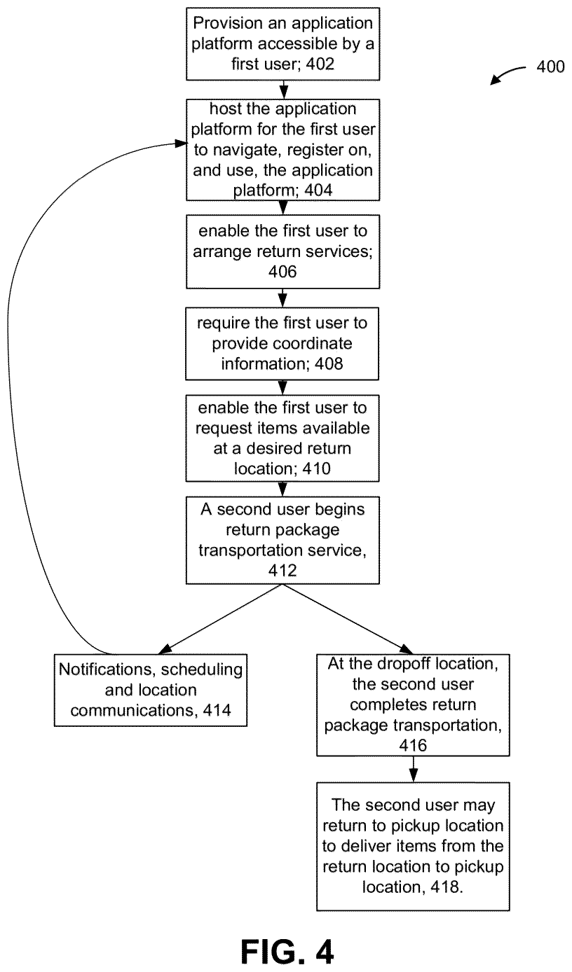

FIG. 4 is a flow diagram of an example method 400 of facilitating return scheduling through a software application and service in accordance with certain embodiments described herein.

The method 400 comprises provisioning an application platform accessible by a first user 402. The method 400 further comprises receiving first user account input for account creation, registration, sign up, access control, authentication, and/or authorization for a software application and service in an operational block 404.

The method 400 further comprises enabling the first user to arrange and/or schedule returns of packages in an operational block 406.

The method 400 further comprises optimizing the route for second user drivers using an Optimized Routing Algorithm after the step in which the application takes steps to require the first user to provide coordinate information of their preferred pickup and drop-off destinations in an operational block 408.

In some embodiments, the method further comprises allowing the first user to select a preferred time for a quantity of return packages to be picked up and a set of predesignated return package drop-off locations. In many embodiments, the quantity of return packages designated for transportation scheduling is required.

The method 400 further comprises facilitating dynamic requests (interrogations) as authorized by the first user account for bidirectional delivery services including dynamic specification of requests for items available at a desired return location by the first user. The desired return location, in any embodiment with or without bidirectional delivery request features, may be selected from preloaded options paired to a set of selected possible return locations, or typed (written) in freeform. This specification/requests for items available at a desired return location may be accomplished through network data filtering which receives live or static database feeds relating to the most likely current inventory and likely product SKU's stocked by any such desired return location, such that a first user may request to initiate a bidirectional return through the application interface. In this case, the bidirectional return may be attempted by the second user, including return package drop-off at a shipping courier location and potential pickup of requested additional items at the drop-off location for return to the original pickup location for the first user's retrieval, also at operational block 410.

The method 400 further comprises implementing surge pricing (valuing) during peak demand times using the Dynamic Pricing Algorithm in an operational block 118. The method 400 further comprises incorporating a rating system for second users/driver service workers and customers using a Worker Matching Algorithm or second user matching mechanism in an operational block 416.

The return package shipment may include several packages up to a certain weight per shipment pickup. After a first user completes all prompts and confirms request transmission, confirmations or notifications may be sent to the first user that a second user has accepted their return along with the second user's current location and distance/time from house. Upon the second user's arrival for return package pick-up, further notifications may be sent to the first user of whether the second user is picking up additional packages or going straight to the return location, and whether the package has been dropped off. If the first user made in-app procurement requests (interrogations), the first user may get a notification about the location of the second user who is transporting the return packages to the drop-off location to keep updated about potential delivery timeframes of the requested items for procurement.

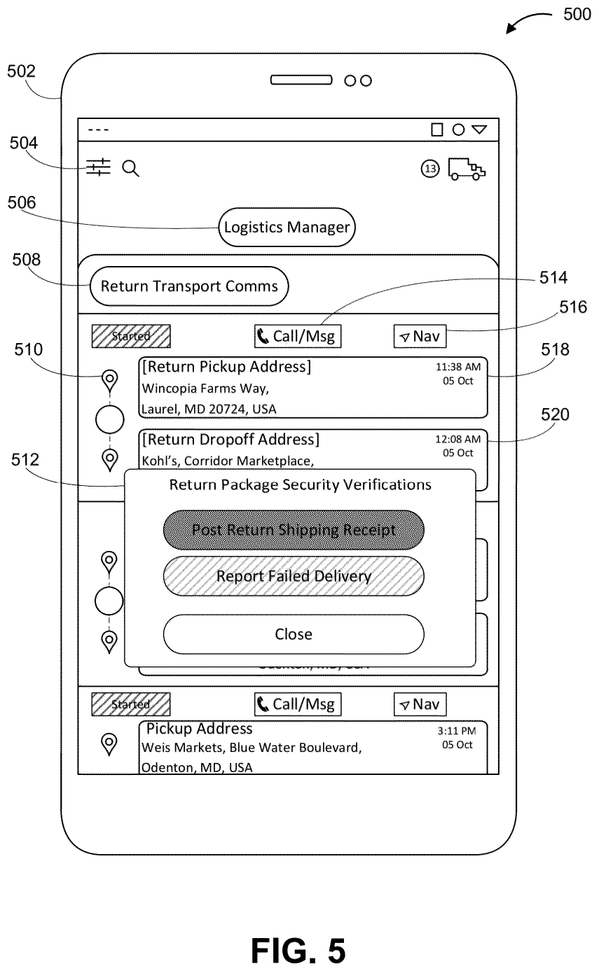

FIG. 5 is a depiction of the second user application interface. It shows a personal device 502 with a settings button 504 in the user interface screen. The displayed screen and menu is part of a Logistics Manager module application area. Second users may download a mobile application like this one to a device with GPS and, in some embodiments, must be 18 or older. In some embodiments, they must then provide basic personal information, fill out contract agreements, submit to a background check, register payment preferences and/or bank account details, and/or schedule work hour preferences.

At the return package drop-off location, mobile device technology is utilized by the second user to reference new procurement pickup request communications from the first user 508 under Return Transport Communications. Further, the second user may be notified by their mobile device software application regarding suggested jobs (tasks) as shown in the Logistics Manager screen 506 or elsewhere in user interface 500. These suggested jobs may include modules to provide return package security verifications upon drop-off by posting a return shipping receipt or reporting a failed delivery, for example. Further options available in user interface 500 may include buttons to call or message the first user 514, navigate 516 to the coordinates which enable the next task to be completed at either return pickup address 518 or return drop-off address 520 for example.

One or more second users who each possess one or more second user devices 502 will provide package transportation and associated services and support as tangentially necessary to the tasks of picking up a return package and delivering it securely to approved drop-off location(s) 520 and/or drop-off location personnel. In some embodiments, a second user will typically be 18 years old or older, pass a background investigation, have a valid driver's license, and/or have access to a vehicle that can carry packages. The second user's primary responsibility is to pick up return packages and deliver them to the drop off location identified by a first user who arranged or requested a return package transportation service. The second user may print shipping labels for first users who may prefer not to print them themselves but rather to provide them through the application interface or via email forwarding to second users. In some system implementations, the shipping labels may be printed with a portable printer device, possessed by the second user, which may be an additional second user device 502, such as a mobile phone, UE, or any of those described in FIG. 1, enabled with a printing accessory function.

In accordance with some embodiments, the second user may access, provide, pack with, and otherwise utilize packing materials for first users who request this and/or for any return packages in apparent need of additional packing and/or packaging regardless of first user request.

In some embodiments, a second user may contact support to obtain assistance, in some embodiments by utilizing network 120 to contact cloud computing system 102. Support may be automated through technology such as FAQ information, repositories of hierarchical information, search results via indexed data or large language models, and/or any other suitable method of delivery such as human voice conversation. In any case, these automations may include such activities as sending physical backup in the form of a second driver/second user to aid with transportation of the first second user and/or any return packages. This backup may occur instead of a roadside assistance or insurance call. Support automations may also include tow truck support, emergency service dispatch, hauling labor, or other support requested by the second user in order to complete any return package transportation tasks.

In accordance with some embodiments, the first user will receive one or more notifications of a delivery via a delivery receipt, photograph, and/or or failed delivery receipt with reasoning for the failure, which may be submitted through Return Package Security Verifications window 512 within the second user's application interface. It is intended that the second user account, in many embodiments, will be required to provide proof of one or more deliveries (all matching those assigned via request by a first user account) with a photograph or other reliable copy of the return receipt. A second user, in many embodiments, will be forbidden from ever opening customer packages and will further be required to return any and all customer packages that cannot be delivered. If packages go missing, in some embodiments, the second user will be held responsible and an investigation will be conducted against the second user and the second user account, such that penalties may be rendered. The cloud computing system 102 is updated via network 120 and second user device 150 any time a second user has a change, which must be relayed, in their license status or any arrest or charge for a crime or driving offense.

Only an authenticated, dedicated administrator of the cloud computing system 102 may have access to view and/or administer first user accounts and information relating thereto. In some embodiments, second users must drop off all return packages at drop-off locations within 90 minutes of when they have been picked up. In some embodiments, a second user is forbidden to possess one or more return packages overnight. In some embodiments, second user accounts are not allowed access permissions to report picking up return packages more than 30 minutes before or 30 minutes after the pickup time arranged, requested, or scheduled by a first user. These timeframes may be variable, for example as little as 5 minutes or as much as 150 minutes before and/or after the requested time/timeslot. In some embodiments, however, the second user takes on personal risk by attempting to pick up the return package at the pickup location before the requested time and/or timeslot, because the return package may not be ready for pickup. The return package may be inaccessible, unpacked, in an unknown location, not in the complete set of return packages requested for pickup, or otherwise not yet ready for pickup.

In some embodiments, a second user account's authorized pickup schedule may fall between the general hours of 6 am and 9 μm or other appropriate hours as beneficial to ensure that a dropoff location is open and actively accepting drop off return packages on the same day as the return package pickup, given closure times of drop off locations. In other embodiments, same day delivery may be enabled through the system such that a second user delivers a first user's return package to the drop-off location without scheduling on a previous day. The package returned may have a maximum value which must be declared during the first user's request process inside the application when initiating a package return request. Further, when initiating the package return request, the first user may be required to attach, link, or otherwise email any associated return label, return code, and/or QR code and/or shipping information supplied by any original vendor(s) of the return package during the first user's original procurement.

User two's device being apart of the system configured for printing a label is easing any burden of someone shipping as user one. The QR code and label is handled with the return package.

In some embodiments, a Load Balancing Algorithm may be implemented to maximize the efficiency of each trip and reduce the number of vehicles on the road. This algorithm would assign packages to drivers based on the capacity of their vehicle and the geographical distribution of pick-ups and deliveries.

In some embodiments, another algorithmic approach may be utilized in the form of a carbon footprint calculator. This would be an algorithm to estimate the carbon footprint of each delivery, encouraging eco-friendly practices. This could factor in vehicle type, route efficiency, vehicle utilization rate as a ratio of packages transported to maximum capacity, and package weight.

In some embodiments, using historical data, an algorithm could support predictive analytics for demand forecasting. This algorithm predicts future package delivery demand, helping to optimize resource allocation and driver scheduling.

In some embodiments, Vehicle Telematics Devices may be utilized. These may take the form of hardware installed in vehicles to monitor vehicle health, fuel efficiency, and to provide real-time data for route optimization algorithms.

In some embodiments, environmentally friendly transportation is provided. This provisioning includes electric 150, manpowered (such as a bicycle 150), or electric or hybrid gas and electric vehicles 150 being utilized by second users to align with the eco-friendly aspect of the systems for provisioning secure transportations.

In some embodiments, smart packaging sensors may be utilized. IoT sensors on packages may provide real-time data on location, condition, and environmental factors (like temperature), ensuring safe and efficient delivery.

These approaches not only optimize this novel solution for provisioning secure return package transportations but also contributes positively to reducing the carbon footprint of package deliveries.

The system and application may use an API passkey to integrate with shipping carriers on the backend, such as UPS, FedEx, etc. This application enables everyday Americans to quickly utilize a simple software application to request and provision return shipping package pick-ups on a flexible schedule. For first users who work in recurring shipments, they can make use of the ability to save user and business information inside the application for expedited administration and paperwork processing of repeat requests (interrogations). This improves efficiency in vehicle utilization for the shipping business in the united states, reducing our greenhouse gas emissions and getting us closer to the atmospheric health status of Europe and other continents with less traffic, smog, and carbon emissions. Further, drivers who have better efficiency may be rated higher within the application and get rewarded better for saving time and miles (gasoline). This may be visible to the first user who may be encouraged to select lower greenhouse gas emitting second users. Both first and second users may have a gamified, shareable point system in which they level up and receive rewards based on vehicle emissions efficiencies on return packages of various types. Points may also be assigned via a review system whereby user accounts are able to rate other user accounts they have interacted or worked with through various package return processes.

In some embodiments, the second user is prompted via their user interface, when logged into their account as required to enable an account-specific user interface, to bring a return package back to a first user-designated pickup location if necessary for any reason such as shipping location closure or refusal to accept the drop-off. In general, the second user can pick up and accept the return package shipment from the original first user's designated return pickup address 518 if a label is on on the package. In another embodiment, they can accept the package even without a label as their second user device is configured with a connected printer component which can manifest as a full printer or any sort of other or mobile printer device. Within this dispatched consumer-to-store logistics operation, the first users and second users may be human, artificial intelligence, self-driving vehicles, or any combination. The first user may request, or otherwise the first user account may automatically trigger a need for, if the package in the system process is over a threshold return package size and/or weight, a specialized second user return which may include a second user account in possession of a larger vehicle or other special second user capabilities.

In general, a first user's requested return package transportation/shipment request may include several packages up to a certain weight per shipment pickup. After completing all prompts and checking out, a first user confirmation will be sent and notifications of when a second user has accepted their return, the second user's current location and distance/time from house, whether the returner is picking up additional packages or going straight to the return location upon arrival/pick-up, and notice when the package has been dropped off. If the customer made in-app purchases, the customer will get a notification about the location of the returner who is bringing the purchased items back.

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed alternatives, variations, modifications, and equivalents are within the literal scope of the following claims, and others are equivalent. The claims may be practiced without some or all of the specific details described in the specification. In many cases, method steps described in this specification can be performed in different orders than that presented in this specification, or in parallel rather than sequentially, or in different computers of a computer network, rather than all on a single computer. It is to be understood that the present technology contemplates that, to the extent possible, one or more features of any implementation can be combined with one or more features of any other implementation.

1. A non-transitory computer-readable medium storing instructions that, when executed by a processor, cause the processor to:
provision an application platform accessible by a first user;
host the application platform for the first user to navigate, register on, and use, the application platform;
enable the first user to schedule return package transportation;
require the first user to provide coordinate information;
enable the first user to request items available at a desired return location.

2. The non-transitory computer-readable medium of claim 1, wherein the coordinate information is further accompanied by information regarding a quantity of packages for return, details of the packages, an approximate size of each package, and a desired return location address.

3. The non-transitory computer-readable medium of claim 1, wherein the items available at the desired return location are either selected from preloaded options paired to a set of selected possible return locations, or written in freeform.

4. The non-transitory computer-readable medium of claim 1, wherein after coordinating the return package transportation, the first user forwards a return label or code into the application platform.

5. The non-transitory computer-readable medium of claim 1, wherein the return package transportation is facilitated by one or more second users who interacts as a return operator role on the application platform.

6. The non-transitory computer-readable medium of claim 1, wherein after the first user interrogation items, the first user will get a notification about a location of a second user who is bringing one or more requested items back.

7. The non-transitory computer-readable medium of claim 1 storing instructions that, when executed by a processor, further cause the processor to:
allowing the first user to select a preferred time for a quantity of return packages to be picked up and a set of predesignated return package drop-off locations.

8. The non-transitory computer-readable medium of claim 1 storing instructions that, when executed by a processor, further cause the processor to:
determine a route for one or more second users to perform a return service using a route optimization mechanism; and
transmit a determined route to the one or more second users.

9. The non-transitory computer-readable medium of claim 8, wherein the route optimization mechanism considers factors such as network load, distance, time of day, and any specific tools required for each task.

10. The non-transitory computer-readable medium of claim 1 storing instructions that, when executed by a processor, further cause the processor to:
determine a conformance of a package drop-off using a return package security verification module:
wherein the return package security verification module uses symbol interpretation and computer vision to analyze a return shipping receipt.

11. The non-transitory computer-readable medium of claim 5 storing instructions that, when executed by a processor, further cause the processor to:
match one or more second users to a package return request using a second user matching mechanism, wherein:
the second user matching mechanism considers factors such as capability, tools, location, and availability of the one or more second users.

12. The non-transitory computer-readable medium of claim 1 storing instructions that, when executed by a processor, further cause the processor to:
allocate resources for a package return request using a resource allocation mechanism, wherein:
the resource allocation mechanism considers factors such as demand, location, and other factors.

13. The non-transitory computer-readable medium of claim 1 storing instructions that, when executed by a processor, further cause the processor to:
verify an identity of one or more first users and one or more second users using a security and verification mechanism; and
ensure security of exchange using the security and verification mechanism, wherein:
the security and verification mechanism uses de-centralized database technology or hardware authentications for secure, transparent exchange.

14. The non-transitory computer-readable medium of claim 1 storing instructions that, when executed by a processor, further cause the processor to:
analyze characteristics of the items for return using a package analysis mechanism considering factors such as weight, size, type, risks of leaks or flammability, compliance status of substances, likelihood of requirements for rates, and risks of packaging breaking.

15. A system for facilitating return coordination through a digital platform, the system comprising:
a user interface for receiving return package transportation coordinating interrogations from one or more first users;
a communication module for transmitting the return package transportation coordinating interrogations to one or more second users and receiving confirmation of the return package transportation coordinating from the one or more second users; and
a notification module for notifying the one or more first users of confirmed return package transportation coordinating.

16. The system of claim 15, further comprising:
a route optimization mechanism for determining a route for the one or more second users to perform a return package transportation; and
the communication module further configured to transmit a determined route to the one or more second users.

17. The system of claim 15, further comprising:
a dynamic rate mechanism for determining a rate for the return package transportation; and
the communication module further configured to transmit the determined rate to the one or more first users.

18. The system of claim 15, further comprising:
a second user matching mechanism for matching the one or more second users to the return package transportation.

19. The system of claim 15, further comprising:
a resource allocation mechanism for allocating resources for the return package transportation.

20. The system of claim 15, further comprising:
a transportation vehicle to be used by the second user, wherein the transportation vehicle is a bicycle, electric, or hybrid gas and electric vehicle.
